(19) United States
(12) Patent Application Publication
(10) Pub. No.: US 2010/0301212 A1
(43) Pub. Date: Dec. 2, 2010

(54) SUBSTRATE-FREE GAS-PHASE SYNTHESIS OF GRAPHENE SHEETS

(75) Inventors: Albert Dato, Pleasanton, CA (US); Michael Frenklach, Orinda, CA (US); Velimir Radmilovic, Piedmont, CA (US); Zonghoon Lee, Albany, CA (US)

Correspondence Address: JOHN P. O'BANION;O'BANION & RITCHEY LLP, 400 CAPITOL MALL SUITE 1550, SACRAMENTO, CA, 95814, US

(73) Assignee: THE REGENTS OF THE UNIVERSITY OF CALIFORNIA, Oakland, CA (US)

(21) Appl. No.: 12/782,596

(22) Filed: May 18, 2010

Related U.S. Application Data
(60) Provisional application No. 61/179,288, filed on May 18, 2009.

(51) Int. Cl. G01N 23/00; C01B 31/02

(52) U.S. Cl. 250/311; 204/173; 250/306

(57) ABSTRACT

A substrate-free gas-phase synthesis apparatus and method that is capable of rapidly and continuously producing graphene in ambient conditions without the use of graphite or substrates is provided. Graphene sheets are continuously synthesized in fractions of a second by sending an aerosol consisting of argon gas and liquid ethanol droplets into an atmospheric-pressure microwave-generated argon plasma field. The ethanol droplets are evaporated and dissociated in the plasma, forming graphene sheets that are collected. The apparatus can be scaled for the large-scale production of clean and highly ordered graphene and its many applications. The graphene that is produced is clean and highly ordered with few lattice imperfections and oxygen functionalities and therefore has improved characteristics over graphene produced by current methods in the art. The graphene that is produced by the apparatus and methods was shown to be particularly useful as a support substrate that enabled direct atomic resolution imaging of organic molecules and interfaces with nanoparticles at a level previously unachievable.

### CROSS-REFERENCE TO RELATED APPLICATIONS

This application claims priority from U.S. provisional application Ser. No. 61/179,288 filed on May 18, 2009, incorporated herein by reference in its entirety.

### STATEMENT REGARDING FEDERALLY SPONSORED RESEARCH OR DEVELOPMENT

This invention was made with Government support under Grant Number DEI-ACO2-05CH11231 awarded by the Department of Energy (DOE) and under Grant Number NCC3-833 awarded by the National Aeronautics and Space Administration (NASA). The Government has certain rights in the invention.

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to synthesis schemes and methods for producing carbon nanostructures, and more particularly to an apparatus and method for gas phase synthesis of graphene sheets.

2. Description of Related Art

Sheets of carbon atoms bonded together in a two-dimensional honeycomb lattice structure one atom thick called graphenes possess remarkable in-plane mechanical, thermal, optical and electronic properties. Graphene is electrically and thermally conductive and has a comparatively high fracture strength, Young's modulus and functional surface area. These properties make graphene a good candidate for use in such applications as micro- and nanoelectronics, batteries, liquid crystal devices, polymer composites, solid-state gas sensors, and hydrogen storage.

However, a major obstacle in the widespread use of graphene in these potential applications is the lack of a large scale graphene synthesis method for producing uniform graphene sheets. While clean and highly ordered graphene exhibits extremely high room-temperature carrier mobility and thermal conductivity, these remarkable properties are very sensitive to defects and disorder within the structure of the sheet. While a perfect graphene structure has a repeating hexagonal form, defects in the formation of the sheet can result in heptagonal or pentagonal structures within the graphene sheet. It has been demonstrated that the formation of defects on pristine graphene sheets results in electrically and thermally insulating behavior. Furthermore, the bonding of oxygen to graphene in the form of functional groups, such as carboxyl and hydroxyl groups, has a detrimental effect on its electronic structure. For example, graphene is a nearly metallic material, while graphene oxide is an insulator. Accordingly, the presence of lattice imperfections and oxygen functionalities on a graphene sheet define its quality.

The production of graphene has proved to be challenging and each of the current methods of isolating graphene have deficiencies. Several different approaches have been taken to produce graphenes. One approach is the use of three-dimensional (3D) crystals or substrates to obtain two-dimensional (2D) graphene through the micromechanical cleavage of graphite. Unfortunately, micromechanical cleavage, where sheets are sheared off of a larger crystal, does not produce graphene sheets that are large enough for practical applications with any reliability or uniformity.

Another method for producing graphene is the chemical reduction of exfoliated graphite oxide. However, the graphenes obtained by the reduction of graphene oxide with strong acids or oxidants have often been shown to contain a significant amount of oxygen and well as a significant number of defects that can change the properties of the graphene.

The chemical reduction of graphene oxide can be scaled up for mass production, but the resulting sheets exhibit defects, disorder, and adsorbed functional groups. For example, the dispersion of graphene oxide paper in pure hydrazine can create micron-sized graphene flakes, but the samples obtained were disordered and elemental analysis revealed that the sheets contained 9% O by mass. Furthermore, yields of only 1% to 12% by weight have been seen. Similarly, the low-temperature flash pyrolysis of a solvothermal product of sodium and ethanol can produce gram-scale quantities of graphene, but the sheets are highly defective and contain even larger quantities of oxygen (18% O by mass).

A further method for graphene production is with the use of a substrate to seed the epitaxial growth of the graphene such as with vacuum graphitization of silicon carbide substrates or the growth of graphene on metal substrates. Large-area graphene has been created by chemical vapor deposition (CVD), but this method is dependent on the quality of an underlying polycrystalline metallic film, and thus the resulting sheets are relatively disordered and consist of regions of varying numbers of graphene layers. Few-layer, rotationally disordered sheets obtained through the vacuum graphitization of SiC exhibit the electronic properties of graphene, but the approach yields graphene layers with small domains, and the high temperatures and ultrahigh vacuum conditions necessary for growth limit the use of this technique in large-scale applications.

Additionally, many of the current plasma techniques aimed at synthesizing carbon nanostructures involve plasma enhanced chemical vapor deposition (PECVD). These methods require substrates and low-pressure environments (below 10 Torr) to obtain carbon nanostructures. The successful synthesis and growth of these that materials proceeds via surface reactions is dependent upon substrate conditions.

Furthermore, graphene synthesized on substrates by epitaxy and CVD requires multiple processing steps, such as wet-etching and micro-fabrication, to obtain transferable sheets. Methods that rely on substrates to obtain graphene also tend to produce sheets that do not have uniform thicknesses and bonding may occur between the bottom graphene layer and the substrate that may affect the properties of the carbon layers.

Current methods of creating graphene that require bulk graphite crystals or complicated methods or expensive substrates, make the large-scale production of graphene by these methods impractical. Furthermore, graphene sheets produced by these methods may have structural imperfections, variable thicknesses, and oxygen functionalities that may negatively influence the properties of the graphene that is produced.

Accordingly, there is a need for an apparatus and method for reliably producing pure and uniformly ordered graphene that is inexpensive and easy to operate. The present invention satisfies these needs as well as others and is generally an improvement over the art.

### BRIEF SUMMARY OF THE INVENTION

The present invention is directed to an apparatus and method for producing very clean, uniform graphene sheets with very few oxygen functionalities that can be used in a variety of applications including composites, electronic devices, sensors, photodetectors, batteries, ultracapacitors, and imaging substrates.

The graphene sheets produced by prior methods are grown in time scales on the order of minutes to hours, and are formed either on substrates, bulk layers of graphite, or other carbon structures. In contrast, the apparatus and methods of the present invention produces graphene sheets with fewer steps and faster speed than current techniques in the art. The method is capable of rapid and continuous synthesis of graphene, without the use of substrates or 3D graphite materials. Graphene sheets are synthesized by the apparatus in fractions of a second by sending an aerosol consisting of argon gas and liquid ethanol droplets into an atmospheric-pressure microwave-generated argon plasma field, in the preferred embodiment of the invention.

An atmospheric-pressure microwave (2.45 GHz) plasma reactor is provided as an illustration. A quartz tube (21 mm internal diameter) located within the reactor is used to pass an argon gas stream (1.71 L/min) through a microwave guide. This stream is used to generate an argon plasma field. A smaller alumina tube (3 mm internal diameter) located concentrically within the quartz tube is used to send an aerosol consisting of argon gas (2 L/min) and ethanol droplets (4×10−4 L/min) directly into the argon plasma field. The ethanol droplets have a residence time on the order of 0.01 seconds to 0.1 second inside the plasma. During this very brief period of time, ethanol droplets rapidly evaporate and dissociate in the plasma, forming graphene and solid carbon matter. After passing through the plasma, reaction products optionally undergo rapid cooling and are collected downstream on nylon membrane filters. The rate of graphene and solid carbon material produced is ˜2 mg/min, for a mass input of carbon in the ethanol of 164 mg/min in the embodiment illustrated.

The graphene produced by the apparatus and method was also shown to be an ideal support for conventional and transmission electron microscopy. Direct imaging of surface molecules and the interfaces between soft and hard materials on functionalized nanoparticles is a great challenge using modern microscopy techniques. For example, nanoparticles coated with molecular layers can self-assemble into novel structures that are envisioned for use in sensors, photonics, and electronics. However, it was shown that the clean, highly ordered graphene of the present invention can be employed as an ultrathin support film that enables direct imaging of molecular layers and interfaces in both conventional and atomic-resolution transmission electron microscopy. The atomic-resolution imaging can be used to directly observe nanoparticles functionalized with a diverse range of molecular coatings, such as DNA, proteins, and antibody/antigen pairs. An atomic-resolution imaging example of the capping layers and interfaces of citrate-stabilized gold nanoparticles was used to demonstrate this novel capability.

An aspect of the invention is to provide an apparatus and method for continuously producing very clean, uniform graphene sheets with low oxygen functionalities that can be used in a variety of applications.

Another aspect of the invention is to provide an apparatus and method that does not use substrates, caustic reagents or complicated procedures to produce graphene.

A still further aspect of the invention is to provide a support for TEM imaging of molecular layers and interfaces between hard and soft materials that can be achieved using graphene.

Another aspect of the invention is to provide a support for atomic-resolution transmission electron microscopy that is uniform and easy to produce.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic drawing of a plasma reactor for producing graphene according to the invention.

FIG. 2A is an EELS spectra of single sheet of synthesized graphene.

FIG. 2B is an EELS spectra of a bilayer sheet of synthesized graphene.

FIG. 3A is a Raman spectra of synthesized graphene sheets in the 2D region.

FIG. 3B is a Raman spectra of synthesized graphene sheets showing D and G peaks.

### DETAILED DESCRIPTION OF THE INVENTION

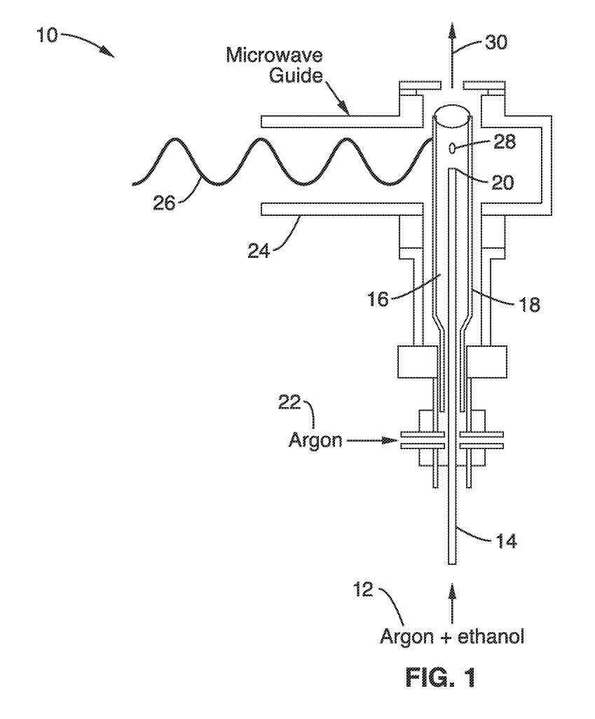

Referring more specifically to the drawings, for illustrative purposes an embodiment of the present invention is depicted in the apparatus generally shown in FIG. 1 and the associated methods for producing high quality and highly ordered graphene sheets. It will be appreciated that the methods may vary as to the specific steps and sequence and the apparatus may vary as to structural details, without departing from the basic concepts as disclosed herein. The method steps are merely exemplary of the order that these steps may occur. The steps may occur in any order that is desired, such that it still performs the goals of the claimed invention.

The present invention provides an apparatus and method for substrate free, gas-phase synthesis of graphene sheets. This single active step method is capable of continuous graphene production in ambient conditions. The technique illustrated with the embodiment of the apparatus shown in FIG. 1 generally involves sending an aerosol consisting of liquid ethanol droplets and argon gas directly into an atmospheric-pressure, microwave-generated argon plasma field.

Turning now to FIG. 1, an embodiment of a microwave-generated plasma reactor is schematically shown. Although a microwave emitter is preferably used to generate plasma, it will be understood that there are other ways to generate plasma that can be used with the methods of the invention. In this embodiment, a controllable source 12 of argon gas propellant and ethanol is attached to a central reactant delivery tube 14 that is preferably configured to expel aerosolized ethanol or other reactant out of the distal tip 20 of the tube 14. In one embodiment, the size of aerosolized droplets of reactant is variable. In another embodiment, the pressure of the ethanol and argon gas mixture within the delivery tube 14 is variable.

The delivery tube 14 is preferably made of alumina and is enclosed within the interior 16 of a reaction chamber 18 that is open at one end. The reaction chamber 18 is preferably made of a material that is essentially transparent to microwaves. A reaction chamber 18 comprising a quartz tube is shown in FIG. 1.

The reaction chamber 18 is also open to a source 22 of argon gas that can introduce a flow of plasma forming gas into the reaction chamber 18 at a rate selected by the user. The rate of gas flow from the source 22 is preferably variable so that the flow of gas can be optimized.

The reaction chamber 18 is disposed within a microwave guide 24 that is configured to direct microwaves 26 from a source of microwaves to the reaction chamber 18 and the aerosolized reactants from tip 20. The microwave energy produces localized argon plasma field 28 within the interior 16 reaction chamber 18. The preferred microwave power provided to the reactor ranges between approximately 250 Watts and approximately 300 Watts. However, although this range of power is preferred, it will be understood that the power can be optimized for the dimensions of the reactor and the efficient production of plasma.

In use, the ethanol or other reactant droplets emerging from tip 20 of reactant pipe 14 and enters into the plasma field 28. The droplets evaporate and disassociate within the plasma 28 forming a graphene stream 30 that cools as it exits the microwave guide and is collected, preferably in nylon membrane filters. Exposure time of the droplets within the plasma 28 can also be varied by adjusting the flow of argon or other flow gas from source 22. The size of the reactant droplets produced at tip 20 will also influence exposure time within the plasma field 28. The preferred time of exposure of aerosolized ethanol droplets in the plasma field 28 range between approximately one hundredth of a second to approximately one tenth of a second in duration.

In the preferred embodiment, the flow of noble gas through the reaction chamber 28 that is the primary source of plasma ranges streams at a rate of between about 1.0 and 2.0 liters per minute. Flow rates can also be optimized as the dimensions of the reaction chamber are scaled up.

The graphene that is produced is clean and highly ordered with few lattice imperfections and oxygen functionalities and therefore has improved characteristics over graphene produced by current methods in the art. It is anticipated that the apparatus and methods of the present invention will substantially reduce the percentage of oxygen functionalities of graphene produced with current synthesis schemes that range from 9% to 18% to a percentage preferably between from 1% to 2%, more preferably from 0.5% to 1%, more preferably from 0.1% to 0.5%, and more preferably less than 0.1% by mass.

The method of gas-phase synthesis of graphene is also expected to yield graphene lattice imperfection rates per sheet preferably in the range from 2% to 5%, more preferably from 1% to 2%, more preferably from 0.5% to 1%, more preferably from 0.1% to 0.5%, and more preferably less than 0.1%.

The invention may be better understood with reference to the accompanying examples, which are intended for purposes of illustration only and should not be construed as in any sense limiting the scope of the present invention as defined in the claims appended hereto.

### EXAMPLE 1

In order to demonstrate the functionality of the apparatus and methods, an atmospheric pressure microwave (2.45 GHz) plasma reactor as shown schematically in FIG. 1 was constructed. A quartz tube (21 mm internal diameter) located within the reactor was used to pass an argon gas stream (1.71 L/min) through a microwave guide. This stream was used to generate the argon plasma. A smaller alumina tube (3 mm internal diameter) located concentrically within the quartz tube was used to send an aerosol consisting of argon gas (2 L/min) and ethanol droplets (4×10−4 L/min) directly into the argon plasma. Ethanol droplets had a residence time on the order of approximately 0.001 seconds inside the plasma.

During the very brief period of time of plasma exposure, ethanol droplets rapidly evaporated and dissociated in the plasma, forming solid matter. After passing through the plasma, the reaction products underwent rapid cooling and were collected downstream on nylon membrane filters. The rate of solid carbon material collected on the filters was 2 mg/min, for a mass input of carbon in the ethanol of 164 mg/min.

Graphene sheets that were collected on the filters were sonicated in methanol for 5 min. The collected sheets were found to easily disperse during sonication, resulting in the formation of a homogeneous black suspension. Droplets of the suspension were then deposited on lacey carbon grids for electron microscopy analysis. A 200 kV Philips CM200/FEG transmission electron microscope equipped with a Gatan Imaging Filter was used to characterize the graphene sheets by transmission electron microscopy (TEM) and electron energy loss spectroscopy (EELS). The graphene sheets were found to be stable under ambient conditions. Some graphene sheets were characterized over 6 months after synthesis demonstrating their stability over time.

Single-layer and bilayer graphene sheets were synthesized at 250 W of applied microwave power in this embodiment. The produced sheets were freely suspended on a lacey carbon TEM grid and appeared as continuous, crumpled sheets exhibiting homogeneous and featureless regions. Previous TEM studies of graphene utilized a combination of TEM imaging and nanobeam electron diffraction patterns to prove that regions of graphene sheets that appeared homogeneous and featureless were regions of monolayer graphene. Less transparent areas can be attributed to the folding and overlap of a single sheet or the overlap of multiple sheets, and the darkest areas are a result of crumpled regions. It can be observed that the sheets are folded in some locations, and it is possible to determine the number of graphene layers in a sheet because of the clear TEM signature provided by these regions. Folded regions are locally parallel to an electron beam, and single-layer graphene has been found to exhibit one dark line, similar to TEM images of single-walled carbon nanotubes.

Bilayer and few-layer graphene sheets have been found to exhibit multiple dark lines in folded regions, such as in the case of multi-walled nanotubes. The monolayer graphene sheets synthesized in the experiments exhibited a single dark line, while bilayer graphene sheets had two dark lines. Interlayer distances were determined by measuring the spacing of the dark fringes. Using GATAN Digital Micrograph 3 software, the average interlayer spacing in the bilayer sheet was determined to be 0.335 nm with a standard deviation of (0.005 nm.)

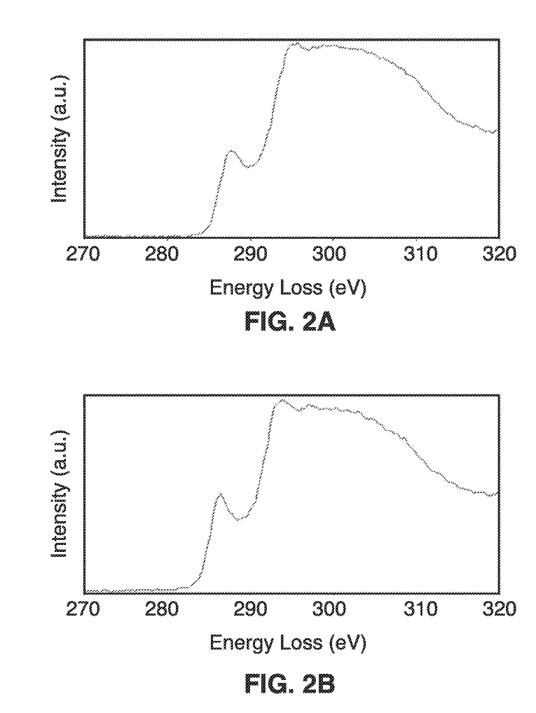

After TEM images were obtained, EELS spectra in the carbon K-edge region were used to investigate the structure of the synthesized sheets. EELS has been shown to unambiguously distinguish between different carbon films, such as diamond, graphite, and amorphous carbon. The main features of a graphite EELS spectrum in the carbon K-edge region are a peak at 285 eV that corresponds to transitions from the 1s to the π* states (1s−π*), and a peak at 291 eV that corresponds to transitions from the 1s to the σ* states (1s−σ*). The graphitic structure of the monolayer sheet observed with TEM imaging was confirmed by its corresponding EELS spectrum as seen in FIG. 2A, which exhibited the 1s−π* and 1sπ* peaks at 285 and 291 eV, respectively. The EELS spectrum for the bilayer graphene sheet also exhibited these characteristics as seen in FIG. 2B.

EELS was also used to investigate the presence of oxygen, hydrogen, and

OH on the graphene sheets. Hydrogen and oxygen K-edge peaks occur at 13 eV and 532 eV, respectively, while OH peaks have been reported to occur at 528 eV. The tested sheets exhibited no detectable hydrogen, oxygen, and OH EELS spectra, which indicated that the sheets were pure carbon.

Raman spectroscopy characterization was also performed on the graphene sheets. Synthesized materials were placed on a silicon substrate, and Raman spectra from a region on the substrate were obtained using a SPEX 1877 0.6 m triple spectrometer at 488 nm, with a 5 cm⁻¹ spectral resolution.

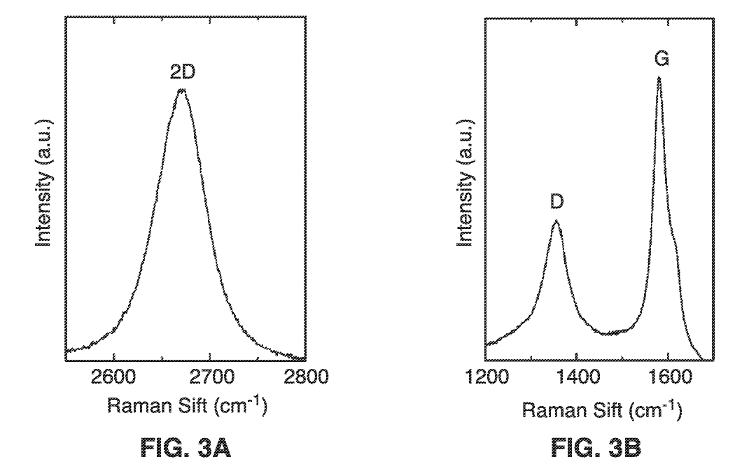

Measurements were performed with an incident power of 40 mW using a spot size of 300 μm×120 μm. The most prominent feature in the Raman spectrum of graphene is the 2D peak, and its position and shape can be used to clearly distinguish between single-layer, bilayer, and few-layer graphene. Single-layer graphene sheets have a single, sharp 2D peak, below 2700 cm⁻¹, while bilayer sheets have a broader and upshifted 2D peak located at ˜2700 cm⁻¹. Sheets with more than five layers and bulk graphite exhibit similar spectra, which have broad 2D peaks that are upshifted to positions greater than 2700 cm⁻¹. As seen in FIG. 3A, the Raman spectrum obtained from the synthesized sheets exhibited a single, sharp 2D peak at ˜2670 cm⁻¹, indicating that the analyzed region consisted of single-layer graphene.

The position and shape of the G peak shown in FIG. 3B provided further evidence that graphene was synthesized. The G peak for graphene sheets occurs at ˜1580 cm⁻¹, and this peak broadens and significantly shifts to 1594 cm⁻¹ for graphite oxide sheets. The G peak of the synthesized sheets is located at ˜1580 cm⁻¹, which shows that oxygen from the ethanol precursor was not present on the graphene sheets.

The appearance of a D peak at ˜1350 cm⁻¹ and a D2 shoulder at 18 1620 cm⁻¹ in the results shown in FIG. 3B was attributed to the presence of structural disorder in graphene sheets. Although these features were present in the Raman spectrum of the synthesized sheets seen in FIG. 3B, the spectrum could not be used to accurately assess the degree of disorder in individual sheets. Edges of graphene sheets are always seen as defects, and peaks indicating a defective structure will appear in the spectra of perfect graphene sheets if the laser spot includes these edges. The characterized samples consisted of multiple overlapping sheets and the presence of the additional peaks could have been the result of many edges captured by the 300 μm×120 μm laser spot. Because of the overlapping nature of the graphene samples, an additional characterization method was used to study individual sheets.

Individual graphene sheets were also characterized using method that combines scanning transmission electron microscopy (STEM) imaging with nano-area parallel beam electron diffraction. Diffraction patterns were obtained using a Zeiss Libra 200/FEG transmission electron microscope, operated at 200 kV with Koehler illumination. First, a region containing graphene sheets was located in TEM mode. Next, using a condenser aperture of 15 μm and a convergent beam size of 5 nm, the high angle dark-field STEM imaging function of the Libra was used to obtain a scanning image of the region.

To obtain a clear diffraction pattern, the STEM stationary beam function of the Libra was then utilized to form a small, nearly parallel beam with a diameter of 300 nm. The STEM image obtained in convergent beam mode was then used as a map to exactly position the parallel beam probe on any area of interest within the STEM image. This technique enabled diffraction patterns of graphene sheets within the region to be obtained. Diffraction patterns were recorded on a charge-coupled device (CCD). By use of the Miller-Bravais indices (hkil) for graphite, each set of diffraction spots exhibited an inner hexagon corresponding to indices (1-110) (2.13 Å spacing) and an outer hexagon corresponding to indices (1-210) (1.23 Å spacing).

Diffraction studies of graphene have shown that the intensity profiles of graphene diffraction patterns could be used to determine the number of layers in a graphene sheet. The relative intensities of diffraction spots in the inner and outer hexagons were shown to be equivalent in single-layer graphene. The relative intensities of the spots in the outer hexagon were shown to be twice those of the spots in the inner hexagon for bilayer graphene. A set of diffraction spots obtained from a synthesized graphene sheet included intensity profiles of equivalent Bragg reflections that showed that the intensities of the inner and outer spots were equivalent, indicating that the set of diffraction spots originated from a single-layer graphene sheet as well as intensity profiles where the intensity of the spot in the outer hexagon was twice the intensity of the spot in the inner hexagon, indicating that the set of diffraction spots corresponded to a bilayer graphene sheet.

The combined results of the Raman measurements and electron diffraction patterns indicate that the quality of the synthesized graphene sheets was better than, or comparable to, graphene obtained by other methods. For instance, the intensity ratio of the D and G peaks in the Raman spectra of graphene has been shown to increase with the degree of disorder in the sheets. Away from the edges, a perfect graphene sheet does not exhibit the D peak. The Raman measurements could not avoid the sample edges, and even then the peak ratio was 0.45 as seen in FIG. 3B, which is lower than the intensity ratios obtained from chemically reduced graphite oxide and PECVD. The latter materials had higher D peak intensities and intensity ratios that approached or exceeded unity. Furthermore, sheets obtained by PECVD methods possessed defective graphite structures and nanographite domains, and diffraction patterns obtained from these materials exhibited blurred diffraction spots, as well as rings originating from amorphous regions on the sheets. The synthesized single-layer and bilayer graphene sheets exhibited sharp, clear diffraction spots that resembled diffraction patterns obtained from graphene sheets created by micromechanical cleavage.

Finally, previous studies have proven that it is possible to create 2D graphene. It was shown that single-layer and bilayer graphene sheets can be synthesized in the gas phase in a substrate-free environment. The atmospheric pressure reactor used in the experiments is simple to operate and capable of continuously producing graphene. Numerous novel materials can be commercially produced in atmospheric-pressure microwave plasma reactors, and the feasibility of producing atomically thin graphene sheets was demonstrated.

### EXAMPLE 2

A second illustration of the functionality of gas phase synthesis apparatus and methods and the quality of the resulting highly ordered graphene sheets was provided using the apparatus shown schematically in FIG. 1. As described previously, an aerosol of liquid ethanol droplets and argon gas was introduced directly into an atmospheric-pressure microwave-generated argon plasma. Over a time scale on the order of 0.001 seconds, the ethanol droplets evaporated and dissociated in the plasma, forming solid matter of clean, highly ordered graphene.

The quality of the synthesized graphene sheets was determined using

Fourier transform infrared spectroscopy (FT-IR), X-ray photoelectron spectroscopy (XPS), elemental analysis by combustion, and an aberration-corrected transmission electron microscope (TEAM 0.5), which is capable of clearly resolving individual carbon atoms, defects, and adsorbates on graphene at an accelerating voltage of 80 kV. No post-synthesis treatments, such as chemical reduction, dispersion in liquids, or thermal annealing, were carried out after the samples were obtained.

Transmission electron microscopy TEM specimens were prepared by depositing the as-synthesized graphene directly onto commercially available TEM grids (lacey carbon 300 mesh Cu grids).

Synthesized sheets were also mixed with KBr powder and compressed into a transparent tablet for FT-IR measurements. The FT-IR spectrum (400-4000 cm⁻¹) of the synthesized graphene was measured using a Nicolet 6700 spectrometer with pure KBr as the background. As-synthesized graphene sheets were deposited onto a Si substrate for XPS analysis, which was conducted using a PHI 5400 ESCA/XPS using an Al Ka radiation source. The spot size used was 1.1 mm in diameter.

A Zeiss Libra 200/FEG TEM was used to obtain low magnification images of synthesized graphene at 200 kV. Individual sheets typically appeared folded and overlapping in low-magnification images, and were as large as several hundred nm. A high-resolution direct image of a synthesized sheet was taken using the TEAM 0.5 and showed the hexagonal arrangement of carbon atoms that is characteristic of graphene. The sheet was observed to be highly ordered and free of adsorbates, even in the regions near the edges.

An atomic-resolution TEAM 0.5 image revealed a highly ordered synthesized single-layer graphene sheet. Prior to this study, such a clean and structurally perfect single-layer sheet had only been observed from graphene obtained from graphite.

FT-IR has been used successfully to detect the presence of functional groups on graphene oxide and chemically exfoliated graphene. Prominent features in the FT-IR spectrum of electrically insulating graphene oxide characteristically include absorption bands corresponding to C—O stretching at 1053 cm⁻¹, C—OH stretching at 1226 cm⁻¹, phenolic O—H deformation vibration at 1412 cm⁻¹, C=C ring stretching at 1621 cm⁻¹, C=O carbonyl stretching at 1733 cm⁻¹, and O—H stretching vibrations at 3428 cm⁻¹. Additionally, one CH₃— and two CH₂— peaks occur at 2960, 2922, and 2860 cm⁻¹, respectively. These features were either absent or minimal in the FT-IR spectrum of the synthesized graphene produced by the present invention.

To verify these findings, an FT-IR spectrum of ball-milled highly oriented pyrolytic graphite (HOPG) was obtained for comparison. The HOPG powder exhibited weak absorption bands at 1200 and 1580 cm⁻¹, in agreement with published transmission spectra of graphite that had been extensively milled. The strong similarity between the FT-IR spectra of the synthesized graphene and HOPG and the absence of other features demonstrated that the produced sheets were free of functional groups.

Additional elemental characterization confirmed the FT-IR results. An XPS spectrum obtained from the synthesized sheets also resembled spectra obtained from HOPG. Elemental analysis by combustion, which measured C, H, and N, revealed that the mass composition of the as-synthesized graphene was 98.9% C, 1.0% H, and 0.0% N (0.1% O by difference). A direct measurement of oxygen also showed that the sheets had a mass composition of 0.1% Oxygen. These results show that oxygen from the ethanol does not bond to the graphene during the synthesis process.

The substrate-free gas-phase method was shown to continuously produce clean and highly ordered free-standing graphene sheets. Milligram amounts of graphene can be collected in minutes with the current apparatus, and it is possible to scale up the process to obtain industrial quantities.

### EXAMPLE 3

Graphene has been proposed as an ideal TEM support because it is atomically thin, chemically inert, consists of light atoms, and possesses a highly ordered structure. Additionally, the material is electrically and thermally conductive, as well as structurally stable. As demonstrated here, the TEM imaging of molecular layers and interfaces between hard and soft materials can be achieved using graphene.

Graphene membranes were synthesized using the substrate-free gas-phase synthesis apparatus and method described above. The resulting graphene sheets were sonicated in ethanol to form a homogeneous suspension. Citrate-capped gold nanoparticles with a 10 nm average diameter were introduced into the suspension, which was then shaken by hand for 30 seconds to form a dispersion of nanoparticles and graphene. A drop of the suspension was deposited onto a Cu TEM grid with a lacey carbon support, which was air-dried prior to TEM characterization. A typical low-magnification image, obtained using a conventional TEM (Zeiss Libra 200 FEG, 200 kV accelerating voltage), revealed that the nanoparticles were exceptionally well-dispersed on the graphene supports.

Single-layer, bilayer, and few-layer sheets were created during the synthesis process, and nanoparticles were observed on each of these species during the experiments. TEM characterization at higher magnifications was carried out on nanoparticles that were located near the edges and planar areas of the graphene sheets. Sheet edges were visible at a defocused condition of −150 nm Intensity profiles showed bright contrast contributed by the edges of the nanoparticle, graphene support, and the amorphous lacey carbon film.

Despite its visibility, the graphene membranes exhibited a much lower contrast variation than the amorphous support. The graphene sheet became nearly indistinguishable from the vacuum in an image of the same region that was taken at a focused condition. The intensity profile showed that the vacuum and graphene had similar intensities, while the contrast of the nanoparticle and amorphous support were still clearly observable.

The noticeable blurred and undulating features that were observed around the nanoparticles indicated the presence of the citrate coating, which was detected because the graphene support was nearly electron-invisible. Although the interface between a nanoparticle and its capping layer was detectable in conventional TEM images, atomic-resolution imaging was required to study the soft-hard interfaces.

An aberration-corrected transmission electron microscope (TEAM 0.5) operating at an accelerating voltage of 80 kV with a monochromated electron beam was used to obtain atomic-resolution images. The hexagonal lattice of carbon atoms in the graphene support and the atomic columns in the cuboctahedral gold nanoparticle could be easily seen. More importantly, the citrate coating and the citrate-gold interface were also clearly visible. This is believed to be the first direct atomic-resolution imaging of surface molecules and interface on a nanoparticle.

The reflections of the gold nanoparticle and graphene sheet were identified through fast Fourier transformed (FFT) digital diffractograms obtained from different regions in the acquired atomic resolution images. An FFT of the graphene sheet exhibited hexagonal spot patterns that were characteristic of graphene. Using the Miller-Bravais indices (hkil) for graphite, the inner hexagon corresponds to indices (1-110) and the outer hexagon corresponds to (1-210), which have lattice spacings of 2.13 and 1.23 Å, respectively. Hexagonal spots corresponding to both the gold nanoparticle and graphene support were clearly distinguishable in digital diffractograms taken at the center of the nanoparticle. The nanoparticle exhibited a strong reflection corresponding to ⅓{422} in reciprocal space, which has a 2.5 Å spacing, and the spots had characteristic relative angles of 60° . Spots corresponding to [111] gold were also visible, such as the (220), (113), and (133) reflections, which have lattice spacings of 1.44, 1.23, and 0.93 Å, respectively. The rotation angle between the nanoparticle and graphene support was about 25 degrees obtained from the digital diffractogram.

The atomic spacings in the gold nanoparticle and its surrounding citrate coating were determined. The profile corresponding to the nanoparticle revealed an average atomic spacing of 2.5 Å, which confirmed the FFT results. The citrate molecules on the nanoparticle were estimated to be 2-3 layers thick, and exhibited a spacing of 3.0-3.5 Å between layers.

Invisibility of the graphene support was achieved by subtracting the periodic contrast of the carbon atoms in the graphene sheet in Fourier space. By masking the graphene reflections from a digital diffractogram of the entire imaged region, the atomic contrast of the graphene honeycomb lattice was removed and an enhanced contrast filtered image of the gold nanoparticle and citrate molecules was obtained. The crystalline structures of the graphene support and gold nanoparticle also enabled the isolated imaging of citrate. A filtered image of the citrate layers was obtained by removing both the graphene and gold reflections.

It can be seen that a graphene support will enable the direct imaging of organic molecules and interfaces with nanoparticles at a level that has been previously unachievable. The detailed fine structure of the coating could be resolved by going to even lower microscope high-tensions and/or much lower temperatures, since the electron irradiation at 80 kV still results in specimen motion. The atomic-resolution imaging can be used to directly observe nanoparticles functionalized with a diverse range of molecular coatings, such as DNA, proteins, and antibody/antigen pairs. The graphene produced by the present invention may also be used in the TEM characterization of a wide variety of organic and inorganic nanomaterials.

From the discussion above it will be appreciated that the invention can be embodied in various ways, including the following:

1. A method for synthesizing a graphene sheet without using a three-dimensional material or substrate, comprising passing liquid ethanol droplets through a plasma field wherein the ethanol droplets evaporate and dissociate in the plasma, forming solid matter; and collecting the solid matter with a collector; wherein the collected solid matter comprises a plurality of graphene sheets.

2. A method according to embodiment 1, wherein said plasma field is produced with a stream of noble gas and microwave radiation.

3. A method according to embodiment 2, wherein said plasma field is produced with a stream of argon gas and microwave radiation.

4. A method according to embodiment 1, further comprising:

forming an aerosol of ethanol droplets with ethanol and a noble gas propellant.

5. A method according to embodiment 4, wherein said gas propellant comprises argon gas.

6. A method according to embodiment 1, wherein said ethanol droplets are exposed to said plasma field for a duration within the range of approximately one hundredth to approximately one tenth of a second.

7. A method according to embodiment 2, wherein said plasma field is produced with applied microwave radiation within the range of between approximately 250 Watts and approximately 300 Watts.

8. A method for synthesizing a graphene sheet, the method comprising:

providing an atmospheric pressure microwave plasma reactor, said reactor having a plasma generator and an internal quartz tube, said quartz tube having an internal alumina tube; passing a continuous noble gas stream through the quartz tube; generating a plasma field within the quartz tube from said noble gas stream; aerosolizing a noble gas and ethanol to form ethanol droplets emitted from said internal alumina tube; directing said ethanol droplets through the quartz tube and directly into the argon plasma; wherein the ethanol droplets evaporate and dissociate in the plasma, forming solid matter; rapidly cooling reaction products and collecting the reaction products on a membrane filter; wherein the collected reaction products comprise a plurality of graphene sheets.

9. A method according to embodiment 8, wherein said plasma field is produced with a stream of noble gas and microwave radiation.

10. A method according to embodiment 9, wherein said plasma field is produced with a stream of argon gas and microwave radiation.

11. A method according to embodiment 8, wherein said aerosol of ethanol droplets is formed from ethanol and argon gas.

12. A method according to embodiment 8, wherein said ethanol droplets are exposed to said plasma field for a duration within the range of approximately one hundredth to approximately one tenth of a second.

13. A method according to embodiment 12, wherein said plasma field is produced with applied microwave radiation within the range of between approximately 250 Watts and approximately 300 Watts.

14. A method for direct imaging of functionalized nanoparticles, comprising: providing a plurality of nanoparticles coated with surface molecules; producing a plurality of graphene sheets by passing liquid ethanol droplets through a plasma field; wherein the ethanol droplets evaporate and dissociate in the plasma field, forming graphene sheets; collecting the graphene sheets with a collector; applying the coated nanoparticles to a surface of said graphene sheets; and imaging said surface molecules on the surface of the nanoparticles the graphene sheets with an imager.

15. A method according to embodiment 14, wherein said plasma field is produced with a stream of argon gas and microwave radiation.

16. A method according to embodiment 14, wherein said nanoparticles comprise gold metal.

17. A method according to embodiment 14, wherein said surface molecules coating the nanoparticles is a molecule selected from the group of molecules consisting essentially of a nucleic acid, a protein inorganic molecules and antibody/antigen pairs.

18. A method according to embodiment 14, wherein said imager is a transmission electron microscope.

19. A method according to embodiment 14, wherein said imaging further comprises: identifying reflections of nanoparticles and graphene sheets with a fast Fourier transform of a diffractogram; subtracting the periodic contrast of carbon atoms of the graphene sheet in Fourier space; and masking reflections of said graphene structure in a final image; wherein molecules on the surface of the nanoparticle can be isolated in a final image.

20. A clean graphene sheet formed according to the process of embodiment 1 or embodiment 8.

21. A clean graphene sheet, wherein the percentage of oxygen functionalities is from 1% to 2% by mass.

22. A clean graphene sheet, wherein the percentage of oxygen functionalities is from 0.5% to 1% by mass.

23. A clean graphene sheet, wherein the percentage of oxygen functionalities is from 0.1% to 0.5% by mass.

24. A clean graphene sheet, wherein the percentage of oxygen functionalities is less than 0.1% by mass.

25. A clean graphene sheet, wherein the percentage of lattice imperfections is from 2% to 5%.

26. A clean graphene sheet, wherein the percentage of lattice imperfections is from 1% to 2%.

27. A clean graphene sheet, wherein the percentage of lattice imperfections is from 0.5% to 1%.

28. A clean graphene sheet, wherein the percentage of lattice imperfections is from 0.1% to 0.5%.

29. A clean graphene sheet, wherein the percentage of lattice imperfections is less than 0.1%.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for synthesizing a graphene sheet without using a three-dimensional material or substrate, comprising:
passing liquid ethanol droplets through a plasma field;
wherein the ethanol droplets evaporate and dissociate in the plasma, forming solid matter; and
collecting the solid matter with a collector;
wherein the collected solid matter comprises a plurality of graphene sheets.

2. A method as recited in claim 1, wherein said plasma field is produced with a stream of noble gas and microwave radiation.

3. A method as recited in claim 2, wherein said plasma field is produced with a stream of argon gas and microwave radiation.

4. A method as recited in claim 1, further comprising:
forming an aerosol of ethanol droplets with ethanol and a noble gas propellant.

5. A method as recited in claim 4, wherein said gas propellant comprises argon gas.

6. A method as recited in claim 1, wherein said ethanol droplets are exposed to said plasma field for a duration within the range of approximately one hundredth to approximately one tenth of a second.

7. A method as recited in claim 2, wherein said plasma field is produced with applied microwave radiation within the range of between approximately 250 Watts and approximately 300 Watts.

8. A method for synthesizing a graphene sheet, comprising:
providing an atmospheric pressure microwave plasma reactor, said reactor having a plasma generator and an internal quartz tube, said quartz tube having an internal alumina tube;
passing a continuous noble gas stream through the quartz tube;
generating a plasma field within the quartz tube from said noble gas stream;
aerosolizing a noble gas and ethanol to form ethanol droplets emitted from said internal alumina tube;
directing said ethanol droplets through the quartz tube and directly into the argon plasma;
wherein the ethanol droplets evaporate and dissociate in the plasma, forming solid matter; and
rapidly cooling reaction products and collecting the reaction products on a membrane filter;
wherein the collected reaction products comprise a plurality of graphene sheets.

9. A method as recited in claim 8, wherein said plasma field is produced with a stream of noble gas and microwave radiation.

10. A method as recited in claim 9, wherein said plasma field is produced with a stream of argon gas and microwave radiation.

11. A method as recited in claim 8, wherein said aerosol of ethanol droplets is formed from ethanol and argon gas.

12. A method as recited in claim 8, wherein said ethanol droplets are exposed to said plasma field for a duration within the range of approximately one hundredth to approximately one tenth of a second.

13. A method as recited in claim 12, wherein said plasma field is produced with applied microwave radiation within the range of between approximately 250 Watts and approximately 300 Watts.

14. A method for direct imaging of functionalized nanoparticles, comprising:
providing a plurality of nanoparticles coated with surface molecules;
producing a plurality of graphene sheets by passing liquid ethanol droplets through a plasma field;
wherein the ethanol droplets evaporate and dissociate in the plasma field, forming graphene sheets;
collecting the graphene sheets with a collector;
applying the coated nanoparticles to a surface of said graphene sheets; and
imaging said surface molecules on the surface of the nanoparticles the graphene sheets with an imager.

15. A method as recited in claim 14, wherein said plasma field is produced with a stream of argon gas and microwave radiation.

16. A method as recited in claim 14, wherein said nanoparticles comprise gold metal.

17. A method as recited in claim 14, wherein said surface molecules coating the nanoparticles is a molecule selected from the group of molecules consisting essentially of a nucleic acid, a protein inorganic molecules and antibody/antigen pairs.

18. A method as recited in claim 14, wherein said imager is a transmission electron microscope.

19. A method as recited in claim 14, wherein said imaging further comprises:
identifying reflections of nanoparticles and graphene sheets with a fast Fourier transform of a diffractogram;
subtracting the periodic contrast of carbon atoms of the graphene sheet in Fourier space; and
masking reflections of said graphene structure in a final image;
wherein molecules on the surface of the nanoparticle can be isolated in a final image.
